(19) United States
(12) Patent Application Publication
(10) Pub. No.: US 2016/0187167 A1
(43) Pub. Date: Jun. 30, 2016

(54) Speed Measuring Device for Ball Pitching Machine

(71) Applicant: Sheng-Hsiao Lu, Tainan City (TW)

(72) Inventor: Sheng-Hsiao Lu, Tainan City (TW)

(21) Appl. No.: 14/585,234

(22) Filed: Dec. 30, 2014

(51) Int. Cl. G01D 11/30; G01P 3/36

(52) U.S. Cl. CPC G01D 11/30; G01P 3/36

(57) ABSTRACT

A speed measuring device includes an adapter pad, two mounting boards, a guide plate, and two speed detection units. The adapter pad includes a base plate and a joint plate adapted to be assembled on a mounting rack of a ball pitching machine. Each mounting board is installed on one of two sides of the base plate and includes spaced first and second sections. The guide plate is assembled on the first sections of the mounting boards. A width between the moveable mounting boards relative to the base plate and longitudinal positions of the two mounting boards relative to the ball pitching machine are respectively adjustable. The speed detection units mounted on inner surfaces of the second sections of the mounting boards define a space through which a ball passes for detecting speed of the ball shot by the ball pitching machine.

### BACKGROUND OF THE INVENTION

1. Field of the Invention

The present invention relates to a speed measuring device and, more particularly, to a speed measuring device adapted to be installed on a ball pitching machine to detect speed of a ball shot by the ball pitching machine.

2. Description of the Related Art

In general, a ball pitching machine with one or two motor-driven rotary wheels is used to shoot baseballs or softballs for hitting or fielding practices of players. For this matter, speed of a ball shot by one ball pitching machine should be detected and adjusted as required during a hitting practice because ball speed is correlated with the hitting skill of a player who is expected to effectively hit a fastball or an off-speed pitch in a real game.

Conventionally, a ball pitching machine depends on a speed gun or a speed detector installed in a practice field for speed detection. However, ball speed detected by the speed gun or speed detector installed outside the ball pitching machine is not accurate enough. Moreover, conventional speed detector cannot be installed on all ball pitching machines with distinct models and sizes.

### BRIEF SUMMARY OF THE INVENTION

Thus, an objective of the present invention is to provide a speed measuring device which is adapted to be installed on different types and sizes of ball pitching machines for properly detecting speeds of balls shot by the ball pitching machines and features a simple structure.

To achieve this and other objectives, a speed measuring device of the present invention includes an adapter pad, two mounting boards, a guide plate, and first and second speed detection units. The adapter pad includes a horizontal base plate and a joint plate adapted to be assembled on a mounting rack of the ball pitching machine. The adapter pad further includes first and second sides spaced in a width direction, and a groove is formed in each of the first and second sides of the base plate and extends in a longitudinal direction perpendicular to the width direction. The mounting boards are respectively assembled on the first and second sides of the base plate. Each of the mounting boards includes a horizontal first section and a vertical second section, and the second sections of the mounting boards are spaced in the width direction. At least one guide slot is formed in the first section of each of the mounting boards. The guide plate is engaged on the first sections of the two mounting boards and has at least one pilot hole formed in each of two sides thereof and corresponding to the guide slot of one of the mounting boards and the groove in one of the first and second sides of the base plate. A plurality of fasteners extends through the pilot holes in the guide plate, the guide slots in the mounting boards, and the grooves in the first and second sides and of the base plate. Each of the first and second speed detection units includes a support plate installed on the second section of one of the mounting boards. The support plates of the first and second speed detection units are spaced in the width direction and define a space therebetween. At least one sensor is mounted on the support plates of the first and second speed detection units for detecting speed of a ball shot by the ball pitching machine through the space. The mounting boards relative to the base plate are movable in the width direction along the guide slots for an adjustable width between the mounting boards. The mounting boards relative to the base plate are movable in the longitudinal direction along the grooves for adjustable positions of the mounting boards opposite to the mounting rack of the ball pitching machine.

In a preferred form, the joint plate extends upward from a rear end of the base plate, and a plurality of mounting holes is formed in each of the first and second sides of the joint plate and spaced in a height direction perpendicular to the longitudinal and width directions. The adapter pad relative to the mounting rack of the ball pitching machine is adjustable in height by extending a screw through one of the mounting holes in each of the first side and second sides. A contacting portion is bent outward from an upper end of the joint plate, and at least one screw penetrates the contacting portion and abuts against the mounting rack of the ball pitching machine.

In a preferred form, two guide slots are formed in the first section of each mounting board, and two pilot holes are formed in each side of the guide plate.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 is a perspective view of a speed measuring device in accordance with an embodiment of the present invention.

FIG. 2 is a perspective view of the speed measuring device in FIG. 1 installed on a ball pitching machine.

FIG. 3 is an exploded view of the speed measuring device in FIG. 1.

FIG. 4 is a top view of the speed measuring device and a mounting rack of the ball pitching machine in FIG. 2.

FIG. 5 is a sectional view taken along section line 5-5 of FIG. 4.

FIG. 6 is a front schematic view which illustrates the speed measuring device in FIG. 1 is adjustable in height.

FIG. 7 is another front schematic view which illustrates the speed measuring device in FIG. 1 is adjustable in width.

### DETAILED DESCRIPTION OF THE INVENTION

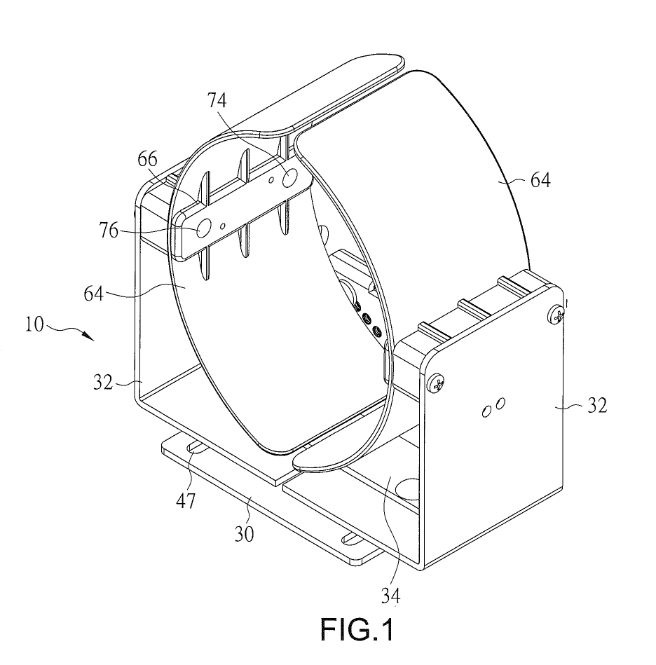

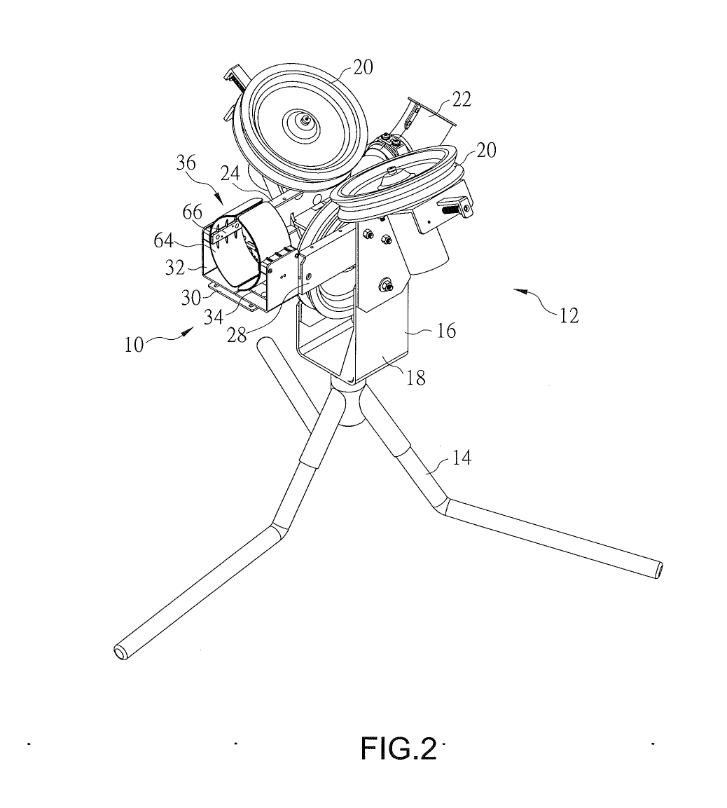

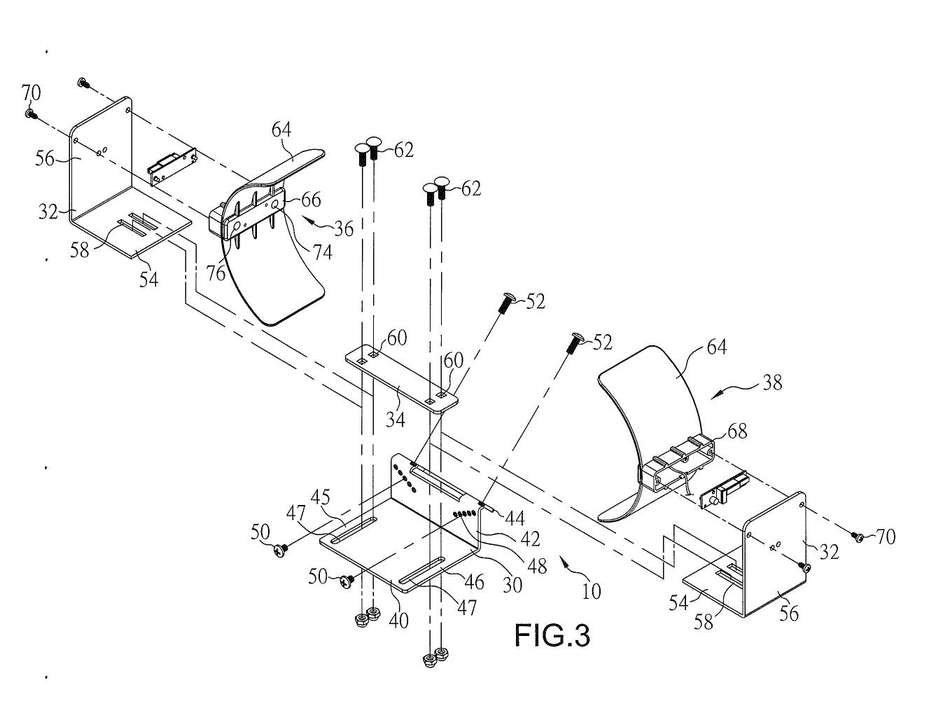

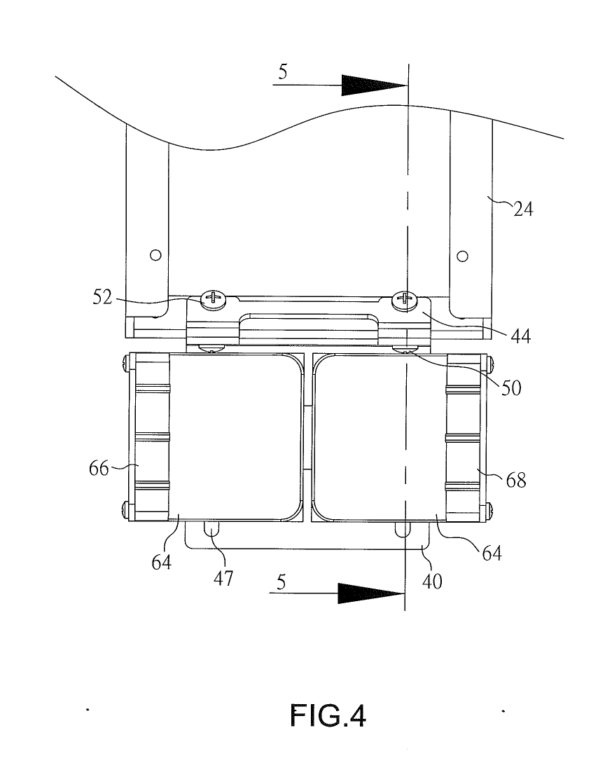

A speed measuring device 10 according to the preferred teachings of the present invention is shown in FIGS. 1 through 7 of the drawings and adapted to be installed on a ball pitching machine 12 which includes a tripod 14, a support seat 16 fitted at the top of the tripod 14, two rotary wheels 20 respectively mounted on two side walls 18 of the support seat 16, a feeding device 22, and a mounting rack 24. The rotary wheels 20 can be driven to spin. Depending on friction to shoot a ball, the rotary wheels 20 contact and drive a ball (baseball or softball), which sinks between the rotary wheels 20 from the feeding device 22, to be shot forward and hit by a player in a batting practice. The mounting rack 24 is a U-shaped member installed in front of the feeding device 22 and includes a base board 26, two upright side panels 28 extending upward from two sides of the base board 26, and an upward joint portion 29 formed on a front end of the base board 26. The ball pitching machine 12 refers to a conventional technique in structure and is not particularly introduced herein.

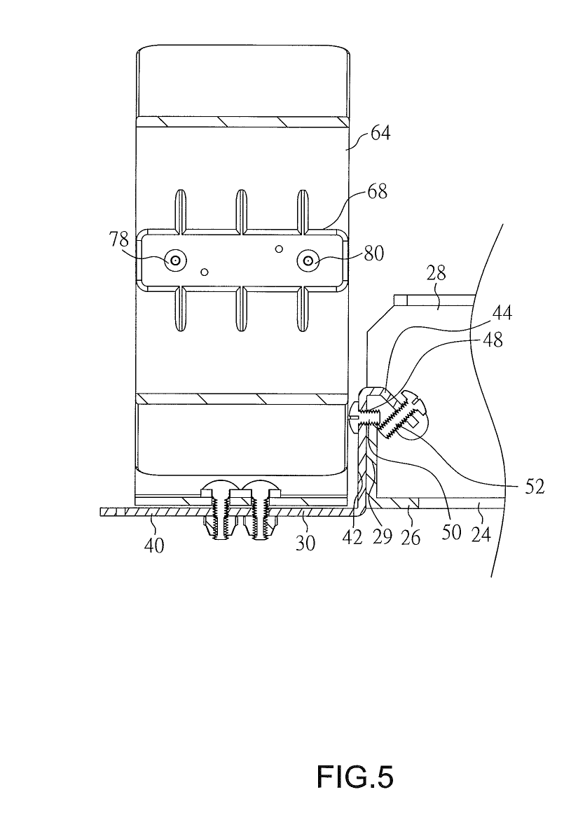

The speed measuring device 10 includes an adapter pad 30, two mounting boards 32, a guide plate 34, and first and second speed detection units 36 and 38. The adapter pad 30 is installed on the ball pitching machine 12 and in front of the feeding device 22, allowing a ball from the ball pitching machine 12 to be passed through the speed measuring device 10 for speed detection. In this embodiment, the adapter pad 30 is an L-shaped member which includes a horizontal base plate 40 and a vertical joint plate 42 extending upward from a rear end of the base plate 40 and including a contacting portion 44 bent outward from an upper end of the joint plate 42. The joint plate 42 is adapted to be coupled with the joint portion 29 of the mounting rack 24 of the ball pitching machine 12 (FIG. 5). The adapter pad 30 further includes first and second sides 45 and 46 spaced in a width direction, and a groove 47 is formed in each of the first and second sides 45 and 46 of the base plate 40 and extends in a longitudinal direction perpendicular to the width direction. A plurality of mounting holes 48 is formed in each of the first and second sides 45 and 46 of the joint plate 42 and spaced in a height direction perpendicular to the longitudinal and width directions. The adapter pad 30 can be fixed on the joint portion 29 and adjusted in height with two screws 50 penetrating one of the mounting holes 48 in the first side 45 and second side 46, respectively. Moreover, the adapter pad 30 can be securely fixed on the mounting rack 24 of the ball pitching machine 12 by screws 52 penetrating the contacting portion 44 and abutting against an inner surface of the joint portion 29 (FIG. 5).

The two mounting boards 32 are assembled on the first and second sides 45 and 46 of the base plate 40, respectively. Each of the mounting boards 32 is an

L-shaped member including a horizontal first section 54 and a vertical second section 56. In the first section 54 is opened at least one guide slot 58. In the embodiment, two guide slots 58 are formed in the first section 54. The guide plate 34 is engaged on the first sections 54 of the two mounting boards 32 and has two pilot holes 60 formed in each of two sides thereof and corresponding to the guide slots 58 of one of the mounting boards 32 and the groove 47 in one of the first and second sides 45 and 46 of the base plate 40. When a plurality of fasteners 62 such as screws penetrate the pilot holes 60 in the guide plate 34, the guide slots 58 in the mounting boards 32 and the grooves 47 in the first and second sides 45 and 46 of the base plate 40, the mounting boards 32 can be securely assembled on the first and second sides 45 and 46 of the base plate 40 and spaced in the width direction. The mounting boards 32 relative to the base plate 40 are movable in the width direction along the guide slots 58 for an adjustable width between the mounting boards 32. Furthermore, the mounting boards 32 relative to the base plate 40 are movable in the longitudinal direction along the grooves 47 for adjustable positions of the two mounting boards 32 opposite to the mounting rack 24 of the ball pitching machine 12.

The first and second speed detection units 36 and 38 respectively include a curved support plate 64. A sensor 66 is mounted on the support plate 64 of the first speed detection unit 36, and a sensor 68 mounted on the support plate 64 of the second speed detection unit 38. The support plates 64 are assembled on inner surfaces of the second sections 56 of the mounting boards 32 with fasteners 70 such as screws and define a space 72 therebetween. The sensors 66, 68 are conventional devices. In the embodiment, the sensor 66 of the first speed detection unit 36 includes first and second light emitters 74 and 76 spaced from each other. The sensor 68 of the second speed detection unit 38 includes first and second light receivers 78 and 80 spaced from each other. Speed of a ball shot by the ball pitching machine 12 and sequentially crossing the sensors 66, 68 within the space 72 can be properly measured with logic circuits, which detect and compute a time difference of signals from the first and second light emitters 74 and 76 spaced by a fixed distance, and indicated on a display (not shown in figures) when light rays emitted from the first and second light emitters 74 and 76 are blocked by the ball. The sensors 66, 68 are just for example, but not for limiting the scope of the present invention. Alternatively, other sensors can be assigned as components installed on the first and second speed detection units 36 and 38 for speed detection.

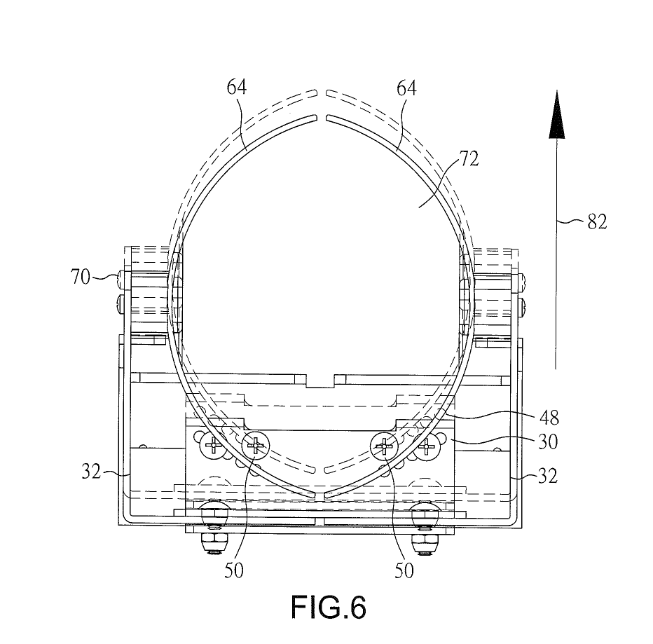

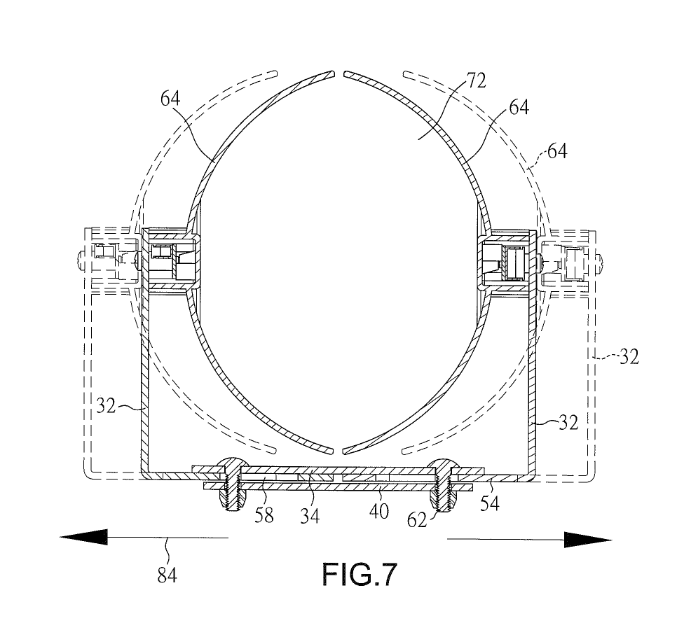

The speed measuring device 10 of the present invention can be installed on different types or sizes of ball pitching machines for accurately detecting speeds of balls from the ball pitching machines. Specifically, with the adapter pad 30 of the speed measuring device 10 assembled on the mounting rack 24 of the ball pitching machine 12, the speed measuring device 10 can properly correspond to the feeding device 22 because a height of the speed measuring device 10 relative to the ball pitching machine 12 is adjustable (arrow 82 in FIG. 6) by the selected mounting holes 48 in the joint plate 42. Moreover, a width between the mounting, boards 32 which are shifted along the guide slots 58 is adjustable (arrow 84 in FIG. 7) with the adapter pad 30 of the speed measuring device 10 fixed on the mounting rack 24 of the ball pitching machine 12. Additionally, longitudinal positions of the mounting boards 32 relative to the mounting rack 24 of the ball pitching machine 12 are adjustable when the mounting boards 32 are shifted along the grooves 47.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A speed measuring device for a ball pitching machine, comprising:
an adapter pad including a horizontal base plate and a joint plate adapted to be assembled on a mounting rack of the ball pitching machine, with the adapter pad further including first and second sides spaced in a width direction, with a groove formed in each of the first and second sides of the base plate and extending in a longitudinal direction perpendicular to the width direction;
two mounting boards respectively assembled on the first and second sides of the base plate, with each of the two mounting boards including a horizontal first section and a vertical second section, with at least one guide slot formed in the first section of each of the two mounting boards and extending in the width direction, with the second sections of the two mounting boards spaced in the width direction;
a guide plate engaged on the first sections of the two mounting boards and having at least one pilot hole formed in each of two sides thereof, with a plurality of fasteners extending through the pilot holes in the guide plate, the guide slots in the mounting boards, and the grooves in the first and second sides and of the base plate; and
first and second speed detection units each including a support plate installed on the second section of one of the two mounting boards, with the support plates of the first and second speed detection units spaced in the width direction and defining a space therebetween, with at least one sensor mounted on the support plates of the first and second speed detection units for detecting speed of a ball shot by the ball pitching machine through the space;
wherein the two mounting boards relative to the base plate are movable in the width direction along the guide slots for an adjustable width between the mounting boards, wherein the two mounting boards relative to the base plate are movable in the longitudinal direction along the grooves for adjustable positions of the two mounting boards opposite to the mounting rack of the ball pitching machine.

2. The speed measuring device according to claim 1, wherein the joint plate extends upward from a rear end of the base plate, with a plurality of mounting holes formed in each of the first and second sides of the joint plate and spaced in a height direction perpendicular to the longitudinal and width directions, with the adapter pad relative to the mounting rack of the ball pitching machine being adjustable in height by extending a screw through one of the mounting holes in each of the first side and second sides.

3. The speed measuring device according to claim 2, wherein a contacting portion is bent outward from an upper end of the joint plate, with at least one screw penetrating the contacting portion and abutting against the mounting rack of the ball pitching machine.

4. The speed measuring device according to claim 1, wherein two guide slots are formed in the first section of each of the two mounting boards, with two pilot holes formed in each of the two sides of the guide plate and corresponding to the guide slots of one of the mounting boards and the groove in one of the first and second sides of the base plate.
